(19) United States
(12) Patent Application Publication
(10) Pub. No.: US 2017/0150709 A1
(43) Pub. Date: Jun. 1, 2017

(54) PORTABLE ATTRACTANT FOR WILD GAME

(71) Applicant: Darren Edward Taylor, Sherwood, AR (US)

(72) Inventor: Darren Edward Taylor, Sherwood, AR (US)

(21) Appl. No.: 14/953,889

(22) Filed: Nov. 30, 2015

(51) Int. Cl. A01M 31/00; A01M 31/06

(52) U.S. Cl. CPC A01M 31/008; A01M 31/06

(57) ABSTRACT

A portable attractant including a container, an absorbent pad and a heat bag is provided. The container is porous to allow scent from the absorbent pad to escape the container. The absorbent pad is disposed within the container and is operable to retain a scent substance within. The heat bag may be disposed in the container adjacent the absorbent pad. The heat bag includes a pouch and a mixture disposed within the pouch. The mixture is configured to produce an exothermic reaction, thereby heating the scent and making the scent exiting the container more prominent.

### BACKGROUND OF THE INVENTION

The present invention relates to hunting and, more particularly, to a portable attractant for wild game.

Traditionally hunters use attractant/cover scents to lure animals closer or use as a method of covering up their own scent in the woods. This process means either pouring prepackaged scent onto the ground, hanging scent dipped wicks from trees, dragging a scent dipped wick behind the hunter, or using some sort of drip or wick to aromatically dispense scent. Each of these methods leaves the wick exposed to the sun, wind, rain, snow, dew, etc. and diluting, drying out, or washing away the very scent being used. Thus, these resources have a maximum effectiveness only in ideal conditions. They are also not truly utilized in a natural state due to the “cold process” or use at current outside temperature. This again is “un-natural” as the core temperature of the animal is 103-105 degrees, thus the aromatic benefits are decreased dramatically.

As can be seen, there is a need for an improved portable attractant for wild game.

### SUMMARY OF THE INVENTION

In one aspect of the present invention, a portable attractant comprises: a porous container; an absorbent pad disposed within the container and operable to retain a scent substance; and a heat bag disposed within the container and comprising a pouch and a mixture disposed within the pouch, wherein the mixture is configured to produce an exothermic reaction.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is an exploded view of an embodiment of the present invention;

FIG. 3 is a perspective view of a cotton wick of an embodiment of the present invention;

FIG. 4 is a perspective view of a heat bag of an embodiment of the present invention;

FIG. 5 is a section view of an embodiment of the present invention along line 5-5 in FIG. 1; and

FIG. 6 is a section view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a portable attractant/cover scent pouch with heat source used for hunting. The present invention not only protects the scent in a breathable, water and moisture resistant pouch, it contains the scent in such a way as to allow it to work longer and more effectively. In part, the method of the present invention increases the effectiveness of the scent and includes a removable and reusable heat source placed within pouch. The present invention heats a replaceable wick to around 105 degrees, replicating scent naturally excreted from the animal. The pouch of the present invention may be breathable yet water resistant, and may be manufactured in multiple colors to be used as shooting or distance indication markers. The reusable heat source can be removed and reused hundreds of times by simply boiling for 10-15 minutes until becoming translucent once again.

Because attractant/cover scents are often byproducts of actual animals, they will often contain a certain amount of oil. The fabric of the container used in the present invention allows a wick to deliver a proper amount of scent. The fabric is breathable and water resistant thus the contained wick is protected from outside elements such as rain, snow, dew, wind, and even the sun. Thus the scent source lasts much longer. Along with this, a heat source is included. The heat source may include a reusable gel pack activated in a chemical process by clicking a dime sized disk included in the gel pack. This causes a chemical reaction that heats the gel pack to 130 degrees. By using the gel pack in conjunction to with the wick, the present invention heats the attractant or cover scent to 105 degrees for a limited amount of time. The heating of the scent allows the scent to be much more effective and puts out a stronger and more natural aroma just as though produced by the animal themselves. The core temperature for the animals is typically 103-105 degrees, thus the present invention artificially replicates the animals own scent in a controlled product.

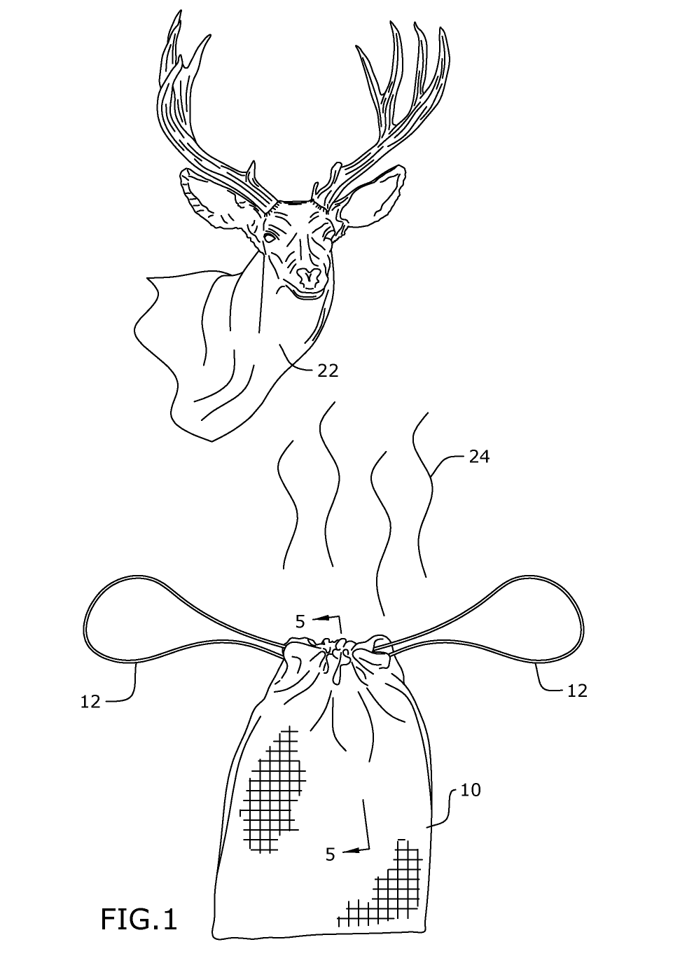

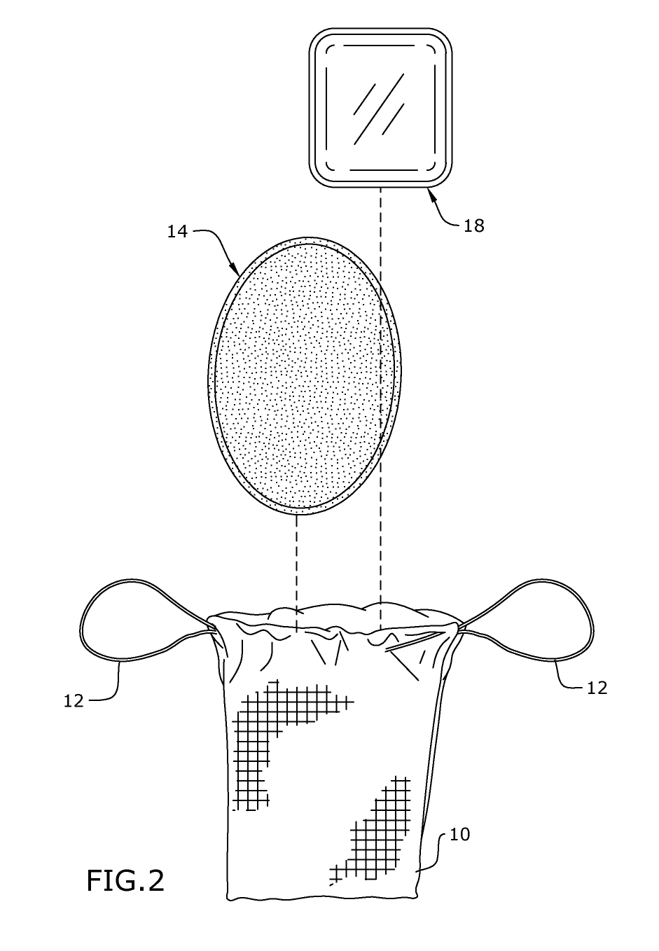

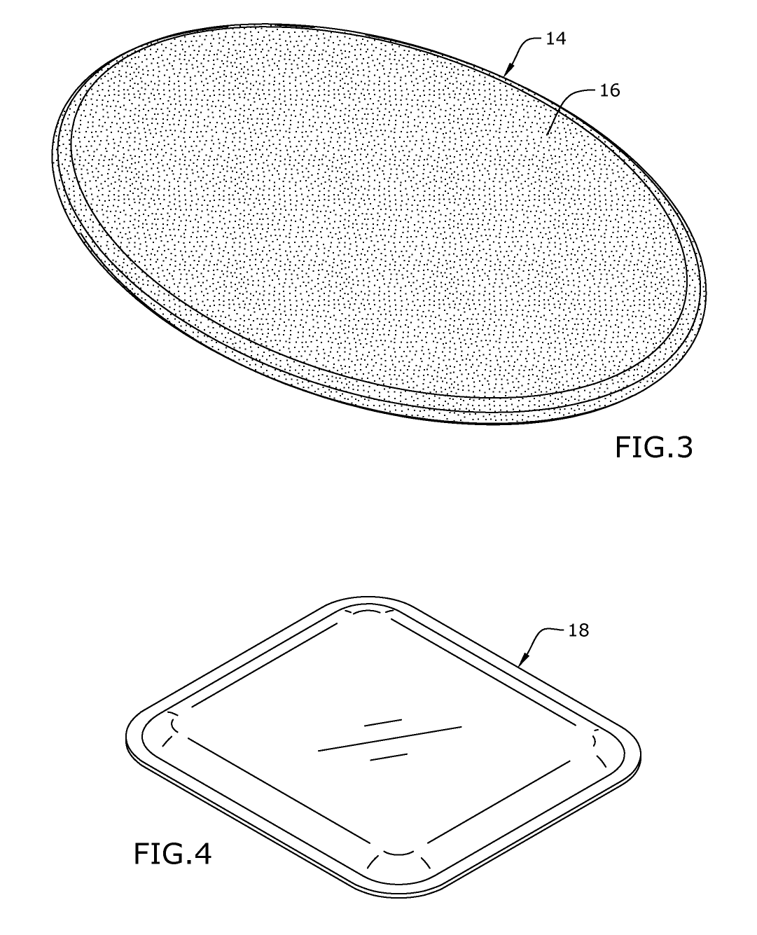

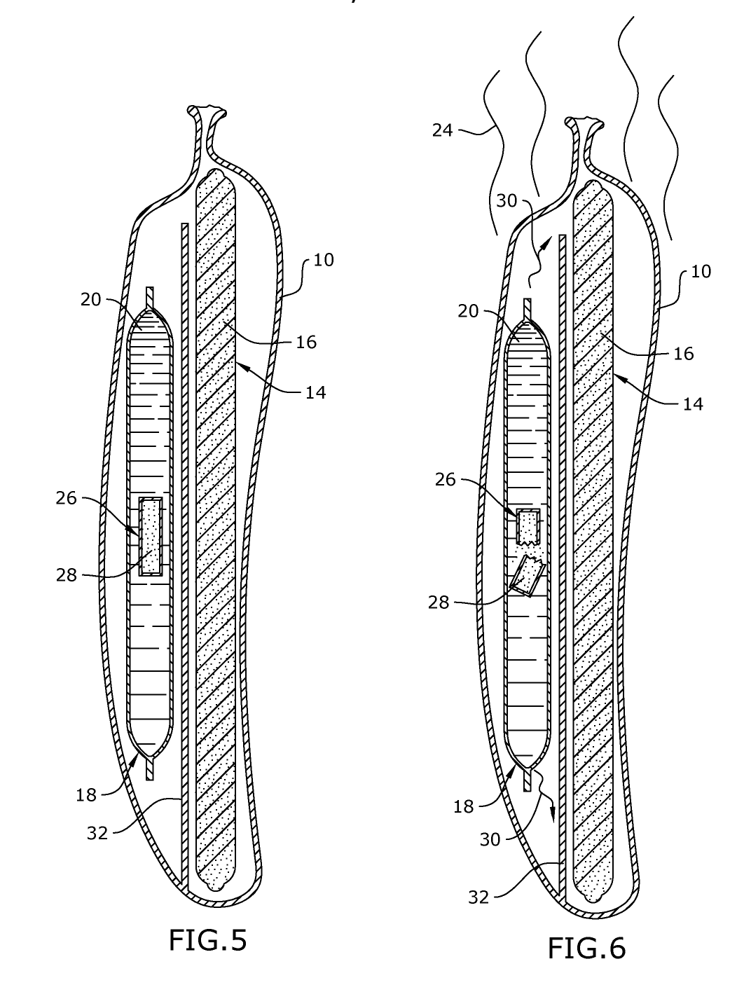

Referring to FIGS. 1 through 6, the present invention includes a portable attractant including a container 10, an absorbent pad 14 and a heat bag 18. The container 10 is porous to allow scent 24 from the absorbent pad 14 to escape the container 10. The absorbent pad 14 is disposed within the container and is operable to retain a scent substance 16 within. The heat bag 18 may be disposed in the container 10 adjacent the absorbent pad 14. The heat bag 18 includes a pouch and a mixture 20 disposed within the pouch. The mixture 20 is configured to produce an exothermic reaction, thereby making the scent exiting the container 10 more prominent.

The porous container 10 of the present invention may include a water resistance pouch. For example, the porous container 10 may be made of a breathable fabric that is tight enough not to allow water to seep through and enter the inside of the container 10. In certain embodiments, the fabric may be treated with a polyurethane coating, thereby making the container 10 waterproof. The porous container 10 includes an entrance leading into the container 10. In certain embodiments, a draw string 12 may be secured to the entrance and is used to open and close the entrance, preventing the absorbent pad 14 and heat bag 18 from escaping the container 10. A divider 32 may be disposed within the container 10 to separate the heat bag 18 and the absorbent pad 14.

The heat bag 18 may include any heat bag 18 that contains a mixture 20 that produces an exothermic reaction. For example, the mixture 20 of the present invention may include a combination of cellulose, iron, water, activated carbon, vermiculite, and salt. In such embodiments, the mixture 20 is operable to produce heat from an exothermicoxidation of iron when exposed to air. The iron powder and the oxygen react together to cause an exothermic reaction which creates heat. The water acts as a reservoir or medium in which both the iron powder and the oxygen react. The salt acts as the catalyst through the water which speeds up the exothermic reaction. The activated carbon disperses the heat evenly throughout the heat bag 18. The vermiculite insulates the reaction in the bag so that the reaction lasts longer. The cellulose takes up the empty space of the bag. In certain embodiments, the mixture 20 may include a supersaturated solution operable to produce heat from an exothermic crystallization. The supersaturated solution may include sodium acetate. In such embodiments, the present invention may include a disk 26 disposed within the heat bag 18. When activated, a chemical reaction 28 activates the exothermic crystallization. To reset the reaction, the heat bag 18 may be boiled.

In certain embodiments, the absorbent pad 14 may be a cotton wick. However, the absorbent pad 14 is not limited to a cotton wick, and may include any absorbent material operable to retain a liquid scent. The scent substance 16 of the present invention is absorbed and retained within the absorbent pad 14. The scent substance 16 may include deer urine, or synthetic deer urine to attract an exemplary game 22, such as a male deer, elk, moose, antelope, coon, skunk, and other wild game. When in use, the heat bag 18 may be activated and produce heat 30, which heats up the cotton wick. The cotton wick delivers a scent 24 through the container 10, thereby attracting the exemplary game 22.

In alternate embodiments, the present invention may utilize different types of heat sources. Further, the present invention may be used with multiple wicks, or a different style of wick. For example, other possible fabrics could be used. The present invention may be made in different sizes and the container may be made of different materials, such as plastics. Further, the present invention may be used with different applications all together. The wick and heat source could be used for aromatic distribution of essential oils or other products where aromatic distribution is needed. Since the fabric is breathable, the present invention allows oils to aromatically pass through while blocking the oil itself from passing though. The present invention may be used in medical field or in the process of any aromatic distribution of a water or oil based scent. Thus the present invention may be used by doctors, massage, or physical therapy to apply the benefits of oils to a client or patient without exposing the skin directly with the oils.

It should be understood, of course, that the foregoing relates to exemplary embodiments of the invention and that modifications may be made without departing from the spirit and scope of the invention as set forth in the following claims.

What is claimed is:

1. A portable attractant comprising:
a porous container;
an absorbent pad disposed within the porous container and operable to retain a scent substance and deliver a scent from the scent substance; and
a heat bag disposed within the container and comprising a pouch and a mixture disposed within the pouch, wherein the mixture is configured to produce an exothermic reaction.

2. The portable attractant of claim 1, wherein the porous container comprises a water resistance pouch.

3. The portable attractant of claim 2, wherein the water resistance pouch is formed of a fabric.

4. The portable attractant of claim 1, further comprising a draw string secured to an entrance formed on the container, wherein the drawstring is operable to open and close the entrance.

5. The portable attractant of claim 1, wherein the mixture comprises cellulose, iron, water, activated carbon, vermiculite, and salt, and wherein the mixture is operable to produce heat from a exothermicoxidation of iron when exposed to air.

6. The portable attractant of claim 1, wherein the mixture comprises a supersaturated solution operable to produce heat from an exothermic crystallisation.

7. The portable attractant of claim 6, further comprising an inner disk disposed within the mixture.

8. The portable attractant of claim 1, further comprising the scent substance absorbed within the absorbent pad.

9. The portable attractant of claim 8, wherein the scent substance is at least one of deer urine and synthetic deer urine.

10. The portable attractant of claim 1, wherein the absorbent pad is a cotton wick.
